(19) United States
(12) Patent Application Publication
(10) Pub. No.: US 2018/0024938 A1
(43) Pub. Date: Jan. 25, 2018

(54) ALLOCATING PHYSICAL PAGES TO SPARSE DATA SETS IN VIRTUAL MEMORY WITHOUT PAGE FAULTING

(71) Applicant: Advanced Micro Devices, Inc., Sunnyvale, CA (US)

(72) Inventors: Timour T. Paltashev, Sunnyvale, CA (US); Christopher Brennan, Boxborough, MA (US)

(21) Appl. No.: 15/216,071

(22) Filed: Jul. 21, 2016

(51) Int. Cl. G06F 12/1009; G06F 12/02; G06F 12/128

(52) U.S. Cl. CPC G06F 12/1009; G06F 12/128; G06F 12/023; G06F 2212/69; G06F 2212/1044

(57) ABSTRACT

A processing system for reduction of a virtual memory page fault rate that includes a first memory to store a dataset, a second memory to store a subset of the dataset, and a processing unit. The processing unit is configured to receive a memory access request including a virtual address and determine whether the virtual address is mapped to a first physical page in the first memory and or a second physical page in the second memory. The processing unit maps a third physical page in a free page pool of the second memory to the virtual address in response to the virtual address not being mapped to the second physical page. The processing unit also grants access to the third physical page that is mapped to the virtual address.

### BACKGROUND

Processing systems implement many applications that operate on sparse datasets that are subsets of (or representative of) a much larger scale complete data set. For example, a volumetric flow simulation of smoke rising from a match in a large space can be represented with a sparse dataset including cells that represent a small volume of the large space that is occupied by the smoke. The number of cells in the sparse dataset may increase as the smoke diffuses from a small region near the match into the large space and consequently occupies an expanding volume in the space. For another example, propagation of light through a large space often is represented by a sparse dataset that includes cells that represent an illuminated volume within the large space. For yet another example, textures used for graphics rendering are stored as a mipmap with multiple levels of detail or the textures are generated on the fly. In either case, texture information is only applied to surfaces of objects in a scene that are visible from the point of view of a “camera” that represents the location of a viewer of the scene during the current frame. Thus, textures are only generated or retrieved from a remote memory and stored in a local memory for a sparse subset of surfaces, levels of detail, or other characteristics that define the textures that are applied to the visible surfaces. For yet another example, visualization systems such as flight simulators or marine simulators may consume or generate a terrain representation that includes large mega-scale and giga-scale partially-resident textures (PRT), which are locally stored portions of a complete set of textures that are stored in a remote memory.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system according to some embodiments.

FIG. 2 is a block diagram of a portion of a processing system according to some embodiments.

FIG. 3 is a block diagram of a local memory system according to some embodiments.

FIG. 4 is a block diagram of a portion of a processing system including an address translation buffer, a local memory, and a remote memory according to some embodiments.

FIG. 5 is a block diagram of the portion of the processing system shown in FIG. 4 following on-demand allocation of a physical page from a free page pool according to some embodiments.

FIG. 6 is a flow diagram of a method for on-demand allocation of physical pages from a free page pool in response to a miss in an address translation buffer generated by a write command according to some embodiments.

FIG. 7 is a flow diagram of a method for on-demand allocation of physical pages from a free page pool in response to a miss in an address translation buffer generated by a read command according to some embodiments.

FIG. 8 is a flow diagram of a method for allocating physical pages to virtual memory that is used to implement portions of a local store and a free page pool according to some embodiments.

FIG. 9 is a flow diagram of a method for reclaiming physical pages from a local store and adding them to a free page pool according to some embodiments.

### DETAILED DESCRIPTION

Virtual memory systems are used to allocate physical memory locations, such as pages in a local memory, to sparse datasets that are currently being used by the processing system instead of allocating local memory to the complete data set. For example, a central processing unit (CPU) in the processing system manages a virtual memory page table implemented in a graphics processing unit (GPU) in the processing system. The CPU allocates pages in the local memory to a sparse data set that stores texture data that is expected to be used to render a scene in one or more subsequent frames. The CPU configures the virtual memory page table to map a subset of the virtual memory addresses used by applications running on the GPU to the allocated physical pages of the local memory. A cache hierarchy may be used to cache recently accessed or frequently accessed pages of the local memory. Compute units in the GPU are then able to access the sparse data set using memory access requests that include the virtual memory addresses. The memory access requests may be sent to address translation caches associated with the cache hierarchy and the local memory. The address translation caches store frequently accessed mappings of the virtual memory addresses to physical memory addresses. Since the dataset stored in the local memory (and the corresponding caches) is sparse, some variations of the compute units in the GPU generate memory access requests to virtual memory addresses that are not mapped to pages of the local memory. In a conventional processing system, a memory access request to an unmapped virtual memory address results in a page fault, which typically causes a very high latency interrupt in processing.

Conventional processing systems implement different techniques for recovering from page faults. For example, CPUs that implement full virtual memory subsystems use “fault-and-switch” techniques to stall the thread that generated the page fault while the requested page is generated or retrieved from a remote memory. In addition, the local memory must be configured to store the requested page, e.g., by rearranging previously stored memory pages to provide space for the requested page. Stalling the thread may also preempt the thread to allow another thread to execute on the processor core. Fault-and-switch techniques therefore often introduce unacceptably long delays for stalled threads in heavily parallel workloads or massively deep, fixed function pipelines such as graphics processing pipelines implemented in GPUs. In order to avoid page faults, some conventional processing systems populate the sparse datasets in the local memory ahead of time (e.g., one or more frames prior to the frame to be rendered using the sparse dataset) using conservative assumptions that require speculatively generating or retrieving larger amounts of data that may or may not be accessed by the workloads. Typically, much of the pre-populated sparse dataset is never used by the workload. Additional system resources are consumed by fallbacks that are created to handle incorrect predictions of the required data and blending that is used to hide “popping” that occurs if the requested data becomes available after a relatively long latency. Furthermore, large latencies are introduced when virtual pages are remapped to physical pages in response to changes in the sparse dataset that is stored in the local memory.

The long latencies incurred by moving portions of a dataset from a remote memory to a local memory implemented by a processing unit such as a graphics processing unit (GPU) can be reduced by allocating one or more physical pages in the local memory to a free page pool associated with an application executing on another processing unit such as a central processing unit (CPU). Physical pages in the free page pool are mapped to a virtual address in response to a memory access request that would otherwise have a page fault. For example, a physical page in the free page pool is mapped to a virtual address in a write command that is used to write data to the virtual address. The physical page is initialized (e.g., to all zeros so that the data in the physical page is in a known state) and the write command writes the data to the physical page that has been mapped to the virtual address. For another example, if a read command attempts to read texture data at a virtual address that is not mapped to a physical address in the local memory, the GPU spawns a process to compute locally the requested texture data and writes the requested texture data to a physical page from the free page pool that is mapped to the virtual address in the read command. Physical pages can be unmapped and returned to the free page pool, e.g., based on information such as access bits or dirty bits that indicate how frequently the physical pages are being utilized. Mapping of the physical pages in the free page pool to virtual addresses, initialization of the physical pages, or unmapping of the physical pages and returning the physical pages to the free page pool is performed by hardware, firmware, or software in the GPU instead of requiring the application (or an associated kernel mode driver) implemented by the CPU to allocate or deallocate physical pages in the local memory.

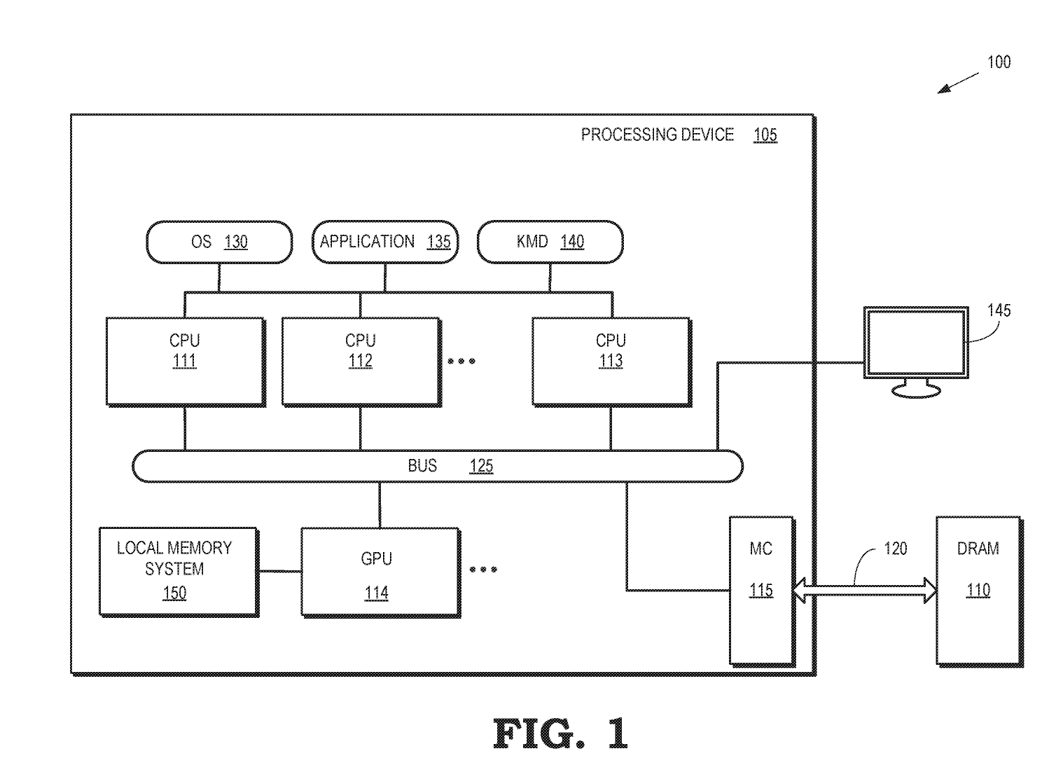

FIG. 1 is a block diagram of a processing system 100 according to some embodiments. The processing system 100 includes a processing device 105 that is connected to one or more external memories such as a dynamic random access memory (DRAM) 110. The processing device 105 includes a plurality of processing units 111, 112, 113, 114 (collectively referred to as the “processing units 111-114”) such as CPUs 111-113 and the GPU 114. For example, the processing device 105 can be fabricated as a system-on-a-chip (SOC) such as an accelerated processing unit (APU) or accelerated processing device (APD) that is formed on a substrate. Each of the processing units 111-114 includes a plurality of processor cores or compute units that concurrently process different instructions. The processing units 111-114 also include one or more resources that are shared by the processor cores, such as caches, arithmetic logic units, floating-point units, branch prediction logic, memory or bus interfaces, and the like.

The processing device 105 includes a memory controller (MC) 115 that is used to coordinate the flow of data between the processing device 105 and the DRAM 110 over a memory interface 120. The memory controller 115 includes logic used to control reading information from the DRAM 110 and writing information to the DRAM 110. The processing units 111-114 communicate with each other, with the memory controller 115, or with other entities in the processing system 100 using a bus 125. For example, the processing units 111-114 can include a physical layer interface or bus interface for asserting signals onto the bus 125 and receiving signals from the bus 125 that are addressed to the corresponding processing unit 111-114. Some embodiments of the processing device 105 also include one or more interface blocks or bridges such as a northbridge or a southbridge for facilitating communication between entities in the processing device 105.

The processing device 105 implements an operating system (OS) 130. Although a single instance of the OS 130 is shown in FIG. 1, some embodiments of the processing device 105 implement multiple instantiations of the operating system or one or more of the applications. For example, virtual machines executing on the processing units 111-114 can execute separate instances of the operating system or one or more of the applications. The processing device 105 also implements one or more applications 135 that generate workloads in the processing device 105 and a kernel mode driver (KMD) 140. Some embodiments of the kernel mode driver 140 are able to map physical pages to virtual pages. However, overhead associated with transitioning the processing device 105 (or one of the processing units 111-114) to the kernel mode limits the number of physical-to-virtual mappings that can be performed in a given time interval, which typically forces the kernel mode driver 140 to perform physical-to-virtual mappings in a batch mode, e.g., by performing a list of physical-to-virtual mappings once per rendered frame in graphics processing.

Some embodiments of the processing device 105 perform graphics processing to render scenes represented by a 3-D model to generate images for display on a screen 145. For example, the DRAM 110 stores a dataset including information representative of the 3-D model. However, in some cases a latency for conveying information between the GPU 114 and the DRAM 110, e.g., via the bus 125 or the memory interface 120, is too large to allow the GPU 114 to render images at a sufficiently high rate to provide a smooth viewing experience for a user.

A local memory system 150 is connected to the GPU 114 by an interconnect that does not include the interface 120 or the bus 125. Consequently, a latency for accessing information stored in the local memory system 150 is lower than a latency for accessing information stored in the DRAM 110. For example, the latency between the GPU 114 and the local memory system 150 is low enough to allow the GPU 114 to render images at a sufficiently high rate to provide a smooth viewing experience for the user. The local memory system 150 stores a subset of the dataset stored in the DRAM 110. For example, the local memory system 150 may store a sparse dataset that includes (or is representative of) the subset of the dataset stored in the DRAM 110. The subset that is stored in the local memory system 150 is retrieved or copied from the DRAM 110, or the information in the subset is generated in response to memory access requests, as discussed herein. The GPU 114 uses the information stored in the local memory system 150 to render portions of the scene to generate an image for display on the screen 145. The GPU 114 transmits information representative of the rendered images to the screen 145 via the bus 125. Although not shown in FIG. 1, in some variations the local memory system 150 or other local memory systems (not shown) can be connected to any of the processing units 111-114 and the local memory systems can be used to store subsets of datasets that are stored in the DRAM 110.

The local memory system 150 implements virtual addressing so that memory access requests from the GPU 114 refer to virtual addresses, which are translated to physical addresses of physical pages in the local memory system 150 or the DRAM 110. Memory access requests including virtual addresses are provided to the local memory system 150 by the GPU 114. The local memory system 150 determines whether the virtual address is mapped to a physical page in the local memory system 150 or a physical page in the DRAM 110. If the virtual address is mapped to a physical page in the local memory system 150, the local memory system 150 grants access to the physical page, e.g., to read information from the physical page or write information to the physical page based on the virtual address. However, if the virtual address is not mapped to physical page in the local memory system 150, the local memory system 150 maps a physical page from a free page pool implemented in the local memory system 150 to the virtual address in the memory access request and grants access to the physical page that is mapped to the virtual address. Thus, the local memory system 150 avoids causing a page fault, which would typically occur if the GPU 114 attempted to access a virtual address that was not mapped to a physical page in the local memory system 150.

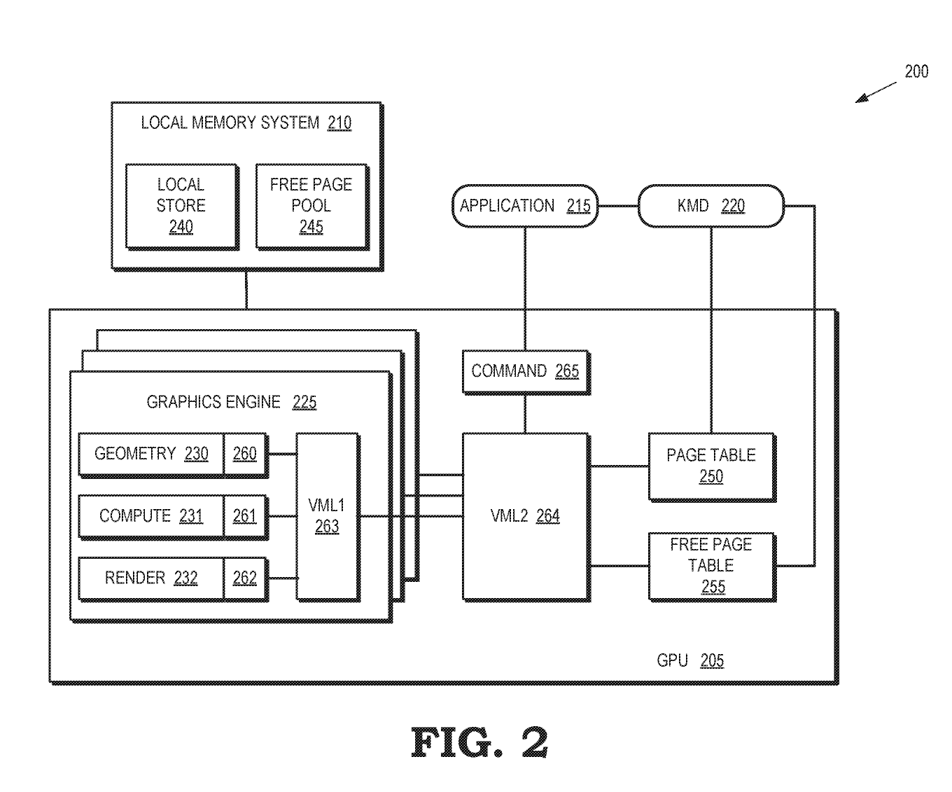

FIG. 2 is a block diagram of a portion 200 of a processing system according to some embodiments. The portion 200 is implemented in some embodiments of the processing system 100 shown in FIG. 1. The portion 200 includes a GPU 205 that is connected to a local memory system 210. The GPU 205 exchanges signaling with one or more applications 215 and a kernel mode driver (KMD) 220, which are implemented in a processing unit such as one of the CPUs 111-113 shown in FIG. 1. The GPU 205 implements one or more graphics engines 225 that are configured as portions of a graphics pipeline, for general purpose computing, or other functionality. For example, a geometry engine 230 in the GPU 205 implements a geometry front-end that processes high-order primitives, a tessellator that receives the high-order primitives and generates lower-order primitives from the input higher-order primitives, and a geometry back-end that processes the low-order primitives. A compute unit 231 in the GPU 205 is configured to perform general purpose computing operations. A rendering engine 232 in the GPU 205 is configured to render images based on the primitives provided by the geometry engine 230. For example, the rendering engine 232 is able to receive vertices of the primitives generated by the geometry engine 230 in object space, e.g., via primitive, vertex, and index buffers. The rendering engine 232 is then able to perform rasterization of the primitives to generate fragments (or pixels) from the input geometry primitives and shade the fragments (or pixels) using applicable textures.

The local memory system 210 is used to store a subset of a complete dataset that is stored in a remote memory such as the DRAM 110 shown in FIG. 1. The subset includes physical pages that are likely to be accessed by the GPU 205 during a subsequent time interval, such as one or more frames. For example, in some variations, the application 215 is a videogame that utilizes the GPU 205 to render images of a scene represented by a 3-D model. A local store 240 includes physical pages that are allocated to the application 215, which is able to access the physical pages using virtual addresses that are mapped to the physical pages. The local memory system 210 also includes a free page pool 245 made up of one or more physical pages that are not currently allocated to an application. The physical pages in the free page pool 245 can be mapped to a first virtual address that is used to reference the physical page before it is in the free page pool 245. Physical pages in the free page pool 245 are mapped to a second virtual address in response to the GPU 205 generating a memory access requests to the second virtual address, which is not mapped to a physical page in the local memory system 210. For example, the subset of the complete dataset stored in the local memory system 210 can be a sparse subset, in which case a memory access request may request a portion of the subset that is not currently stored in the local memory system 210. Adding a physical page from the free page pool 245 to the local store 240 and mapping its physical address to the second virtual address in the memory access request allows the memory access request to be granted without causing a page fault, as discussed herein.

A page table 250 is included in the GPU 205 and used to store mappings of virtual addresses to physical addresses of physical pages in the local memory system 210 or a remote memory such as the DRAM 110 shown in FIG. 1. A free page table 255 is used to store information indicating the physical pages that are included in the free page pool 245. Some embodiments of the free page table 255 include registers that indicate a number of pages in the free page pool 245.

Some embodiments of the local memory system 210 also implement a cache hierarchy (not shown in FIG. 2) that includes caches for caching data or instructions for the GPU 205. A corresponding set of address translation buffers 260, 261, 262, 263, 264 (collectively referred to herein as “the address translation buffers 260-264”) that include physical-to-virtual address mappings that have been frequently or recently accessed by corresponding entities such as the GPU 205, the graphics engine 225, the geometry engine 230, the compute unit 231, or the rendering engine 232. For example, the address translation buffer 260 stores physical-to-virtual address mappings that have been frequently or recently accessed by the geometry engine 230, the address translation buffer 261 stores physical-to-virtual address mappings that have been frequently or recently accessed by the compute unit 231, and the address translation buffer 262 stores physical-to-virtual address mappings that have been frequently or recently accessed by the rendering engine 232. A higher level address translation buffer (VML1) 263 stores physical-to-virtual address mappings that have been frequently or recently accessed by the graphics engine 225 and the highest level address translation buffer (VML2) 264 stores physical-to-virtual address mappings that have been frequently recently accessed by the GPU 205.

A command processor 265 receives commands from the application 215 and executes the commands using the resources of the GPU 205. The commands include draw commands and compute dispatch commands, which cause the command processor 265 to generate memory access requests. For example, the command processor 265 can receive a command from the application 215 instructing the GPU 205 to write information to a memory location indicated by a virtual address included in the write command. For another example, the command processor 265 can receive a command from the application 215 instructing the GPU 205 to read information from a memory location indicated by a virtual address included in the read command. The application 215 is also configured to coordinate operation with the kernel mode driver 220 to allocate memory in the local store 240, as well as add or monitor physical pages in the free page pool 245.

As the commands are executed, the graphics engines 225 translate virtual addresses to physical addresses using the address translation buffers 260-264. However, in some cases the address translation buffers 260-264 do not include a mapping for a virtual address, in which case a memory access request to the virtual address misses in the address translation buffers 260-264. The address translation buffer 264 is therefore configured to add physical pages from the free page pool 245 to the local store 240 and map the added physical page to a corresponding virtual address. For example, the address translation buffer 264 pulls a free physical page from the free page pool 245 when a dynamically allocated surface (e.g., a surface generated by the geometry engine 230) touches a page of virtual memory that has not yet been mapped to a physical page. The address translation buffer 264 then updates the page table 250 with the new virtual-to-physical mapping and removes the information indicating the physical page from the free page table 255. Some embodiments of the address translation buffer 264 are configured to serialize and manage the free page pool 245 and update the page table 250 concurrently with mapping the physical pages from the free page pool 245 to virtual addresses. Some embodiments of the page table 250 also store access bits and dirty bits associated with each of the allocated physical pages. The application 215 or the kernel mode driver 220 are able to use the values of the access bits or the dirty bits to select physical pages that are available to be reclaimed and added to the free page pool 245, e.g., by unmapping the physical-to-virtual address mapping and updating the page table 250 and the free page table 255 accordingly.

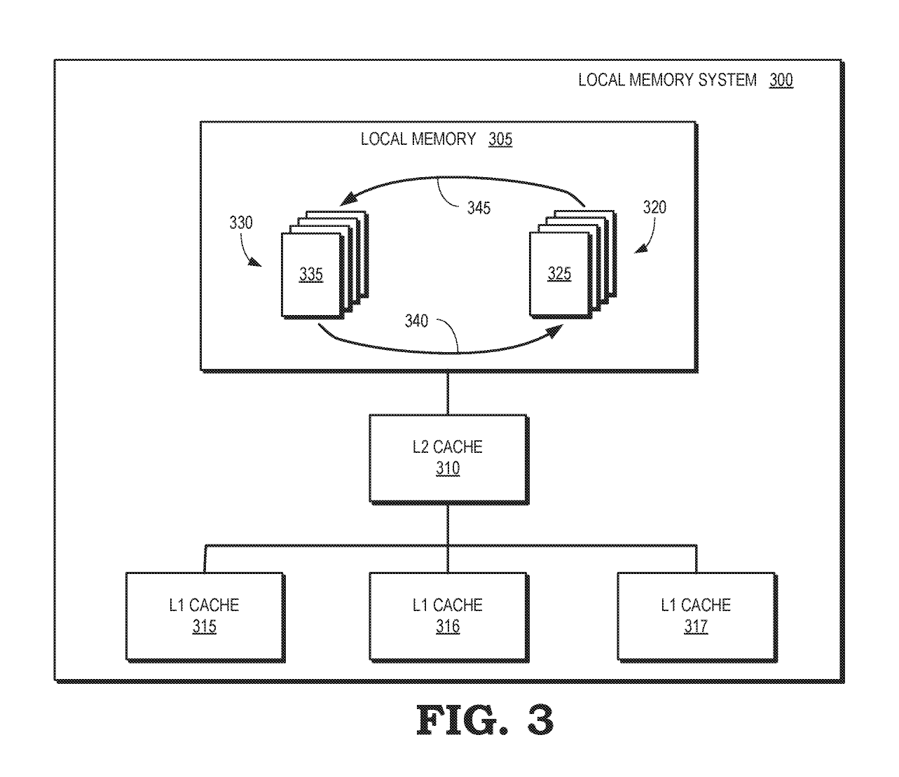

FIG. 3 is a block diagram of a local memory system 300 according to some embodiments. The local memory system 300 is implemented in some embodiments of the local memory system 150 shown in FIG. 1 or the local memory system 210 shown in FIG. 2. The local memory system 300 includes a local memory 305 that is connected to a cache hierarchy including a higher level L2 cache 310 and lower level L1 caches 315, 316, 317, which are collectively referred to as the L1 caches 315-317. Some embodiments of the L2 cache 310 are inclusive of the L1 caches 315-317 so that entries in the L1 caches 315-317 are also stored in the L2 cache 310. Physical pages in the local memory 305, the L2 cache 310, and the L1 caches 315-317 are accessible using virtual addresses that are mapped to the physical addresses of the physical pages. The local memory 305, the L2 cache 310, and the L1 caches 315-317 are therefore associated with address translation buffers, such as the address translation buffers 260-264 shown in FIG. 2, which include mappings of virtual addresses to the physical addresses of the physical pages in the corresponding local memory 305, L2 cache 310, or L1 caches 315-317.

The local memory 305 includes a local store 320 of physical pages 325, which are allocated to applications such as the application 215 shown in FIG. 2. Copies of some of the physical pages 325 are stored in the L2 cache 310 and respective fractions of them in the L1 caches 315-317. The local memory 305 also includes a free page pool 330 that includes physical pages 335 that have not been mapped to virtual addresses and are therefore available for on-demand allocation, e.g., in response to memory access requests to a virtual address that is not mapped to a physical page in the local store 320. On-demand allocation of one of the physical pages 335 maps the physical page to a virtual address and adds the mapped to physical page to the local store 320, as indicated by the arrow 340. The newly mapped physical page is therefore accessible (e.g., the physical page can be written to or read from) by entities in a processing system such as the GPU 114 shown in FIG. 1 or the GPU 205 shown in FIG. 2.

Mapped physical pages can also be reclaimed from the local store 320 and returned to the free page pool 330, as indicated by the arrow 345. For example, an application or a kernel mode driver such as the application 135 and the kernel mode driver 140 shown in FIG. 1 or the application 215 the kernel mode driver 220 shown in FIG. 2 decides whether to reclaim a physical page based on information such as access bits that indicate how frequently a mapped physical page has been accessed or dirty bits that indicate whether information stored in the mapped physical page has been propagated to other memories or caches in the processing system to maintain cache or memory coherency. Physical pages that are accessed less frequently or have fewer dirty bits may be preferentially reclaimed relative to physical pages that are accessed more frequently or have more dirty bits. Reclaimed physical pages are unmapped from their previous virtual addresses and become available for subsequent on-demand allocation.

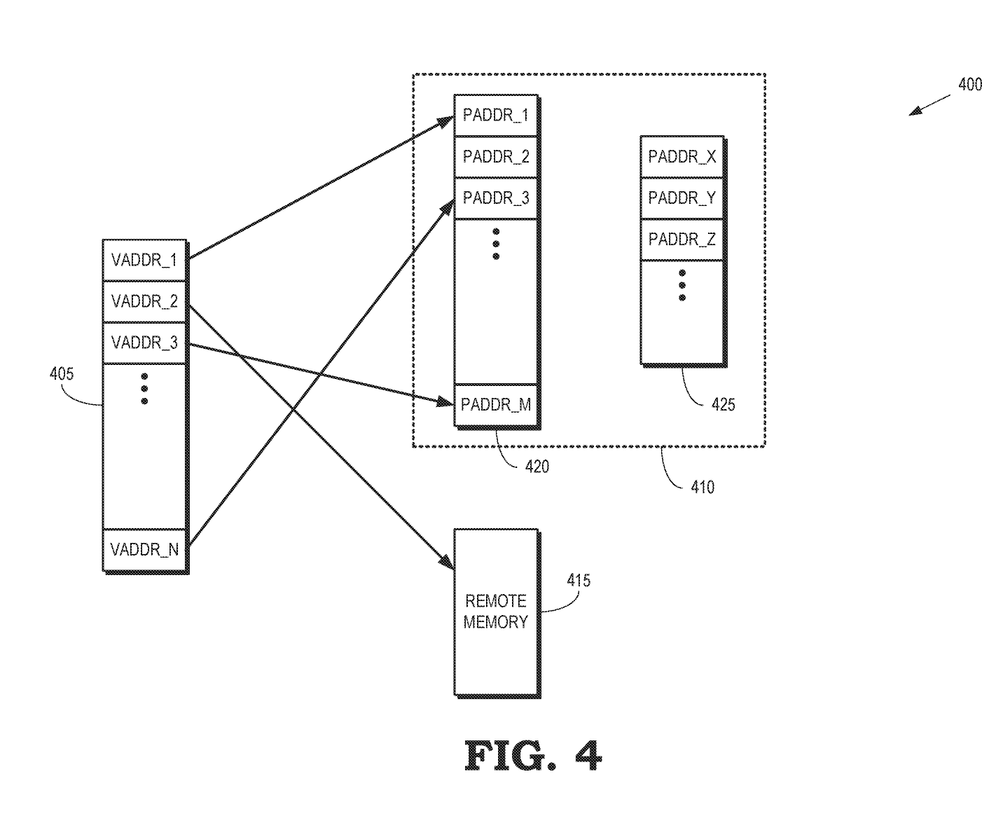

FIG. 4 is a block diagram of a portion 400 of a processing system including an address translation buffer 405, a local memory 410, and the remote memory 415 according to some embodiments. The portion 400 is implemented in some embodiments of the processing system 100 shown in FIG. 1. The local memory 410 and the remote memory 415 are implemented in some embodiments of the local memory system 150 and the DRAM 110 shown in FIG. 1, respectively. The address translation buffer 405 is implemented in some embodiments of the address translation buffers 260-264 shown in FIG. 2.

The local memory 410 includes a local store 420 of physical pages that are addressed by physical addresses such as PADDR_1, PADDR_2, PADDR_3, and PADDR_M. The local memory 410 also includes a free page pool 425 of physical pages addressed by physical addresses such as PADDR_X, PADDR_Y, and PADDR_Z. The physical pages and the corresponding physical addresses in the local store 420 and the free page pool 425 may or may not be contiguous with each other. Although not shown in FIG. 4 in the interest of clarity, the remote memory 415 also includes physical pages that are addressed by corresponding physical addresses.

The address translation buffer 405 indicates mappings of virtual addresses to the physical addresses in the local memory 410 and the remote memory 415. The address translation buffer 405 includes a set of virtual addresses (VADDR_1, VADDR_2, VADDR_3, and VADDR_N) and corresponding pointers that indicate the physical addresses that are mapped to the virtual addresses. For example, the address translation buffer 405 indicates that the virtual address VADDR_1 is mapped to the physical address PADDR_1 in the local store 420, the virtual address VADDR_3 is mapped to the physical address PADDR_M in the local store 420, and the virtual address VADDR_N is mapped to the physical address PADDR_3 in the local store 420. The address translation buffer 405 also indicates that the virtual address VADDR_2 is mapped to a physical address in the remote memory 415. In some variations, some of the virtual addresses in the address translation buffer 405 are not mapped to a physical address.

Memory access requests that include the virtual addresses VADDR_1, VADDR_2, and VADDR_N will hit in the address translation buffer 405 because these virtual addresses are mapped to physical addresses in the local memory 410. Memory access requests that include the virtual address VADDR_2 will miss in the address translation buffer 405 because this virtual address is mapped to a physical address in the remote memory 415. A miss in the address translation buffer 405 would lead to a page fault in a conventional processing system. However, the processing system that includes the portion 400 is configured to allocate a physical page from the free page pool 425 and map the physical page into a virtual address indicated in the address translation buffer 405 instead of causing a page fault. Physical pages from the free page pool 425 can be added to the local store 420 in response to a miss in the address translation buffer 405 that occurs because the corresponding virtual address is not mapped to any physical address.

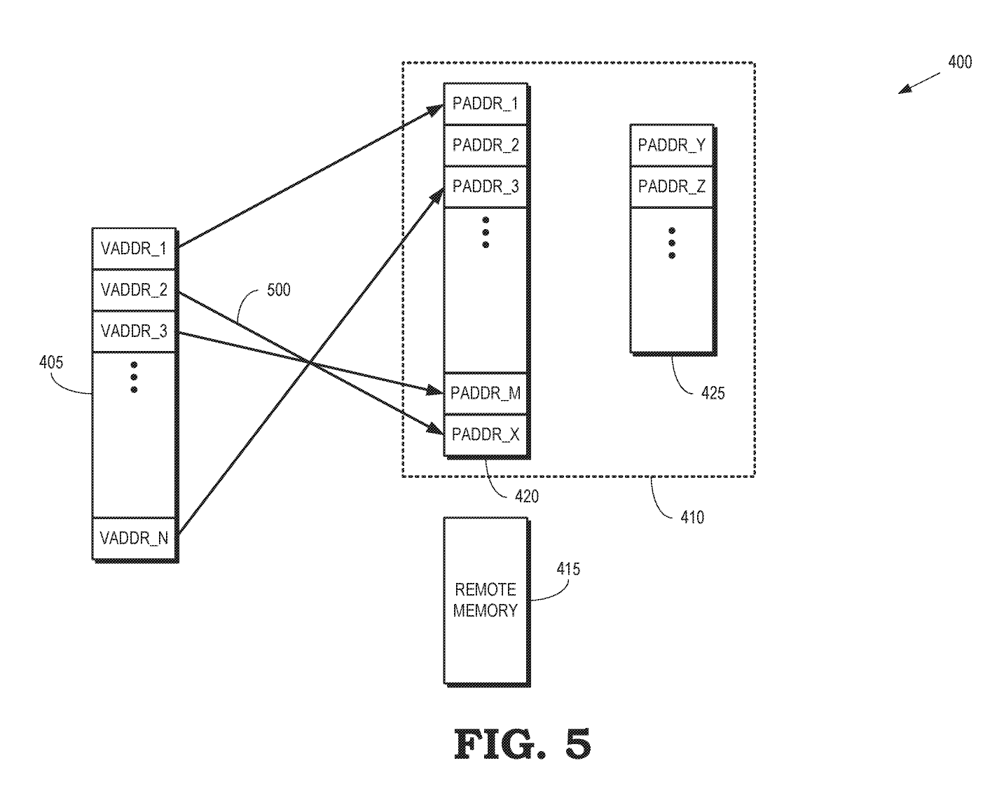

FIG. 5 is a block diagram of the portion 400 of the processing system shown in FIG. 4 following on-demand allocation of a physical page from a free page pool according to some embodiments. In response to a miss in the address translation buffer 405 at the virtual address VADDR_2, a physical page indicated by the physical address PADDR_X has been pulled from the free page pool 425 and mapped to the virtual address VADDR_2, as indicated by the pointer 500. The physical page indicated by the physical address PADDR_X is now a part of the local store 420 and is no longer one of the available physical pages in the free page pool 425. The physical page indicated by the physical address PADDR_X is therefore made available for access to a GPU that is connected to the local memory 410 without interaction or intervention by another processor such as a CPU and without causing a page fault that would conventionally be needed to retrieve physical pages from the remote memory 415.

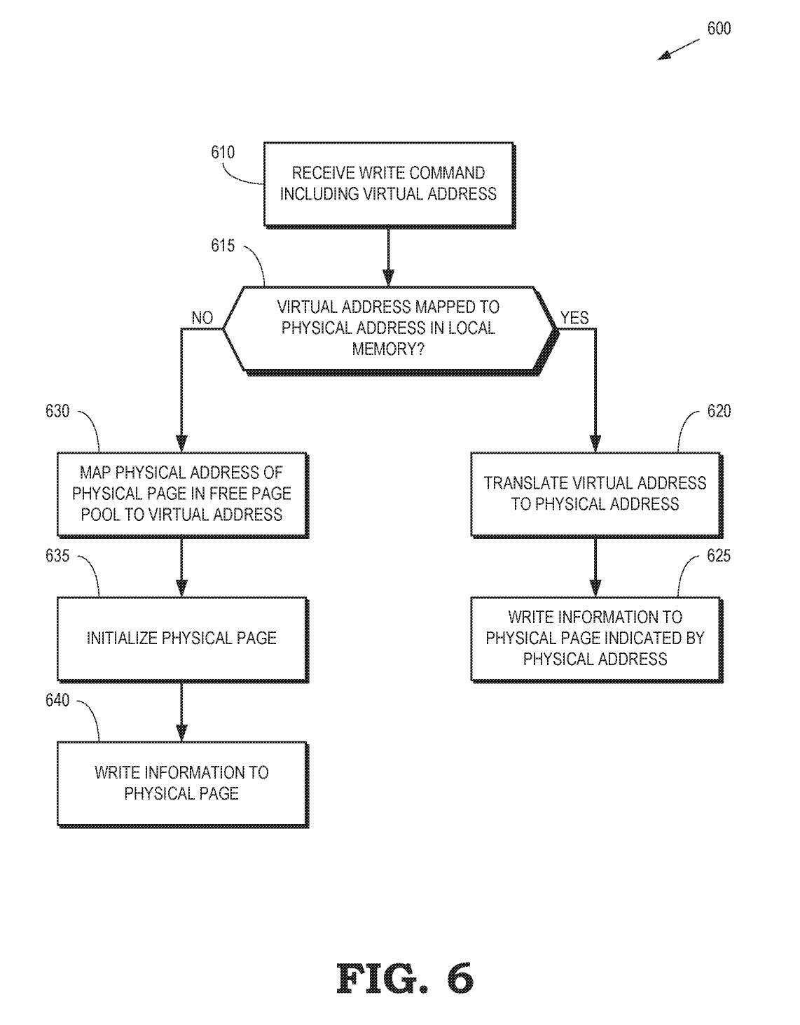

FIG. 6 is a flow diagram of a method 600 for on-demand allocation of physical pages from a free page pool in response to a miss in an address translation buffer generated by a write command according to some embodiments. The method 600 is implemented in an address translation buffer such as some embodiments of the address translation buffer 264 shown in FIG. 2.

At block 610, a write command is received that includes a virtual address indicating a location that is to be written by the write command. At decision block 615, the address translation buffer determines whether the virtual address is mapped to a physical address of a physical page in the local memory. If so, the address translation buffer translates the virtual address to the physical address that indicates the physical page in the local memory at block 620. The information indicated by the write command is then written (at block 625) to the physical page indicated by the physical address that corresponds to the virtual address in the write command. If the virtual address is not mapped to a physical address of a physical page in the local memory, the method flows to block 630.

At block 630, a physical address of a physical page in the free page pool is mapped to the virtual address. The physical page is therefore removed from the free page pool and added to the local store. In some embodiments, mapping the physical address to the virtual address includes updating page tables, free page tables, and other address translation buffers to reflect the mapping of the physical page to the virtual address. At block 635, the physical page is initialized to a known state such as all zeros. At block 640, the write command writes information to the physical page based on the virtual address. In some embodiments, the information that is written to the physical page is propagated to other memories or caches based on memory or cache coherence protocols.

Implementing on-demand allocation of physical pages from the free page pool in response to write commands improves the speed and efficiency of the processing system. For example, applications such as physical simulations or games frequently determine the physical pages that need to be written during execution of the application as the physical pages are being written by the application. On-demand allocation of the physical pages removes the need to perform a pre-pass to estimate the number and addresses of the physical pages that could potentially be written in the future. This approach also conserves memory by removing the need to conservatively estimate the number of physical pages that could potentially be written by the application during a particular time interval, which typically leads to numerous physical pages being loaded into the local store and mapped to virtual addresses, but never accessed.

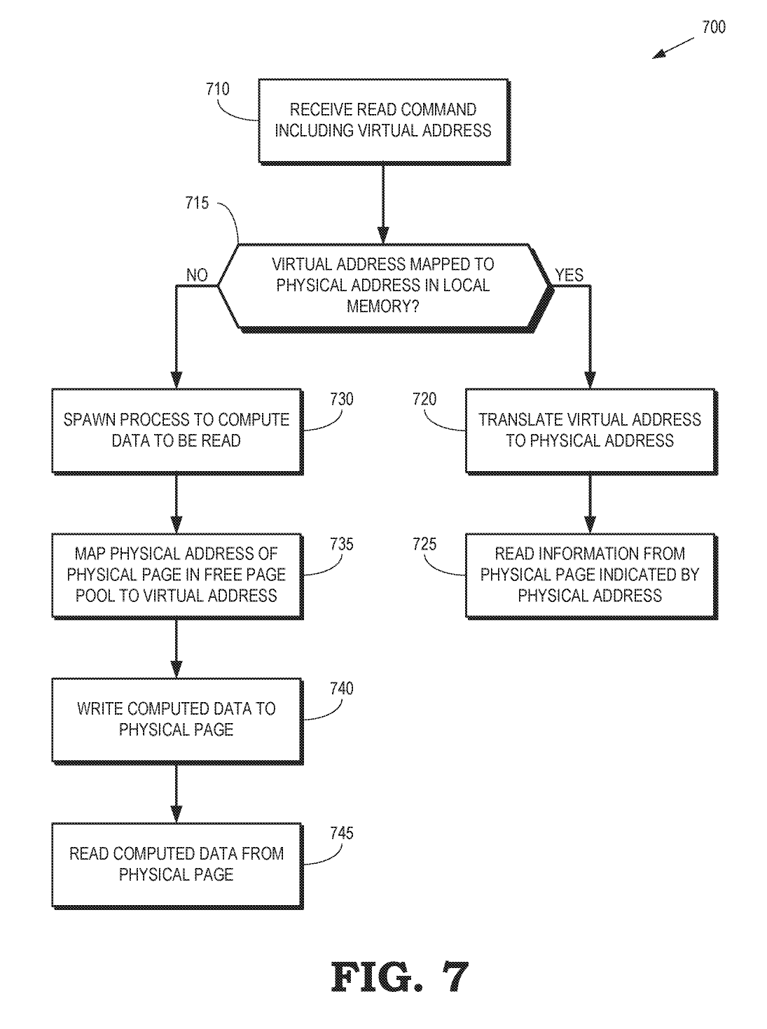

FIG. 7 is a flow diagram of a method 700 for on-demand allocation of physical pages from a free page pool in response to a miss in an address translation buffer generated by a read command according to some embodiments. The method 700 is implemented in an address translation buffer such as some embodiments of the address translation buffer 264 shown in FIG. 2.

At block 710, a read command is received that includes a virtual address indicating a location that is to be read by the read command. At decision block 615, the address translation buffer determines whether the virtual address is mapped to a physical address of a physical page in the local memory. If so, the address translation buffer translates the virtual address to the physical address that indicates the physical page in the local memory at block 720. The physical page indicated by the virtual address in the read command is then read (at block 725) from the physical page indicated by the physical address that corresponds to the virtual address in the read command. If the virtual address is not mapped to a physical address of a physical page in the local memory, the method flows to block 730.

At block 730, a new local compute process is spawned to generate the data that is to be read. Some embodiments of the process are executed concurrently or in parallel with the current process that includes the read command. For example, if the read command is being executed by one graphics engine implemented by the GPU, the newly spawned process is executed by another graphics engine implemented by the GPU.

At block 735, a physical address of a physical page in the free page pool is mapped to the virtual address in the read command. The physical page is therefore removed from the free page pool and added to the local store. In some embodiments, mapping the physical address to the virtual address includes updating page tables, free page tables, and other address translation buffers to reflect the mapping of the physical page to the virtual address. At block 740, the spawned process writes the computed data to the physical page indicated by the virtual address. In some variations, an application such as the application 135 shown in FIG. 1 or the application 215 shown in FIG. 2 provides the process that is used to write the computed data to the physical page. At block 745, the read command reads the computed information from the physical page based on the virtual address. In some embodiments, the information that is written to the physical page by the spawned process (and read from the physical page by the read command) is propagated to other memories or caches based on memory or cache coherence protocols.

Implementing on-demand allocation of physical pages from the free page pool in response to read commands (e.g., by spawning a concurrent process to write the requested information to a physical page pool from the free page pool) improves the speed and efficiency of the processing system. For example, in the case of a GPU that is performing rendering that requires reading sparse texture data that is generated by the GPU, only the physical pages that correspond to surfaces rendered by the GPU are generated, which reduces the consumed memory by eliminating the need to conservatively estimate the physical pages that need to be generated in advance. In addition, the physical pages that are generated and mapped to virtual addresses on-demand do not require interaction with or intervention by one or more CPUs such as the CPUs 111-113 shown in FIG. 1. Instead, the GPU receives a “miss” response from one or more address translation buffers when the GPU executes a read command for an unmapped virtual address. The miss response is used to spawn a computation to generate the data and write it back to a new page which is then immediately available for reading without CPU interaction or intervention.

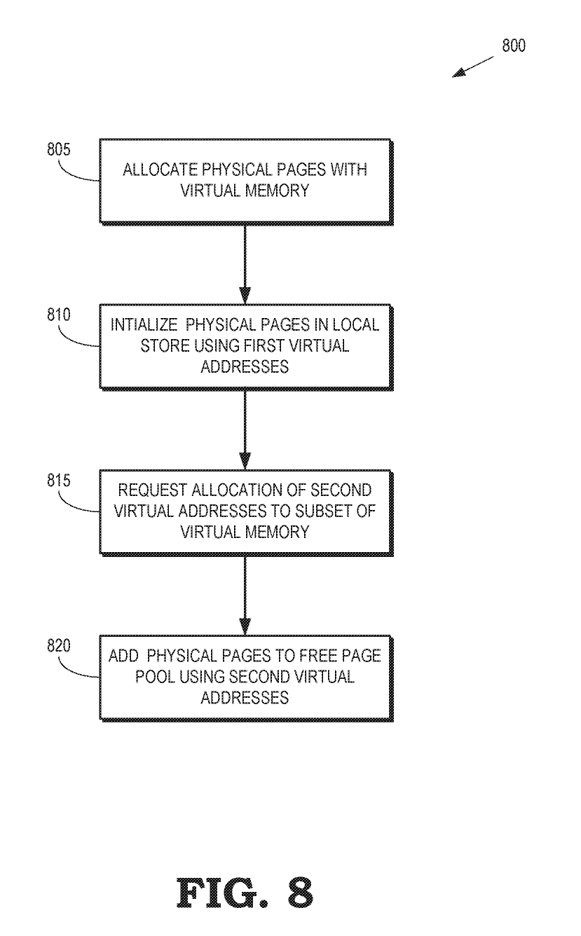

FIG. 8 is a flow diagram of a method 800 for allocating physical pages to virtual memory that is used to implement portions of a local store and a free page pool according to some embodiments. The method 800 is implemented in some embodiments of the processing system 100 shown in FIG. 1 and the portion 200 of the processing system shown in FIG. 2. In some embodiments, the physical pages are allocated by an application or a kernel mode driver such as the application 135 and the kernel mode driver 140 shown in FIG. 1 or the application 215 and the kernel mode driver 220 shown in FIG. 2.

At block 805, the application requests allocation of physical pages with virtual memory that is associated with the application. The kernel mode driver receives the request and allocates the physical pages to the virtual memory. For example, the application can allocate physical memory by requesting a virtual memory allocation that is mapped to physical memory. The physical pages that have been allocated to the virtual memory can therefore be accessed using a corresponding range of (first) virtual addresses. At block 810, the application or the kernel mode driver initializes the physical pages in the local store using the first virtual addresses. In some variations, the application or the kernel mode driver initializes the physical pages to a known state, e.g., by initializing the physical pages to all zeros. Initializing the physical pages to a known state allows the application to write to only a small subset of a physical page after the physical page has been dynamically allocated from the free page pool because the remainder of the page has been initialized to the known value.

At block 815, the application requests allocation of a second set of virtual addresses to a subset of the virtual memory. At this point in the method 800, the second set of virtual addresses do not have physical memory mapped to them. Thus, the application is not able to directly access physical pages using second virtual addresses in the second set.

At block 820, the application requests that the kernel mode driver add physical memory to the application's free page pool. Since the application has only been allocated the second set of virtual addresses, which are not yet mapped to physical memory, the application indicates the physical pages that are to be added to the free page pool using first virtual addresses in the first virtual address range that was allocated at block 805. The kernel mode driver translates the first virtual addresses into physical addresses of physical pages that are then added to the application's free page pool. Once the physical pages have been added to the free page pool, they are mapped to corresponding second virtual addresses in the second set of virtual addresses. In some embodiments, the number of physical pages that are initially allocated to the free page pool is predetermined and the number is determined based upon analysis of previous allocations of physical pages to the free page pool. As discussed herein, physical pages can be pulled from the free page pool into the local store in response to read or write misses. Pulling a physical page from the free page pool into the local store is done by changing the virtual address of the physical page from the second virtual address that references the free page pool to a new virtual address that references the local store. Thus, the actual number of physical pages that are available in the free page pool fluctuates as physical pages are added to the local store or reclaimed from the local store, as discussed herein.

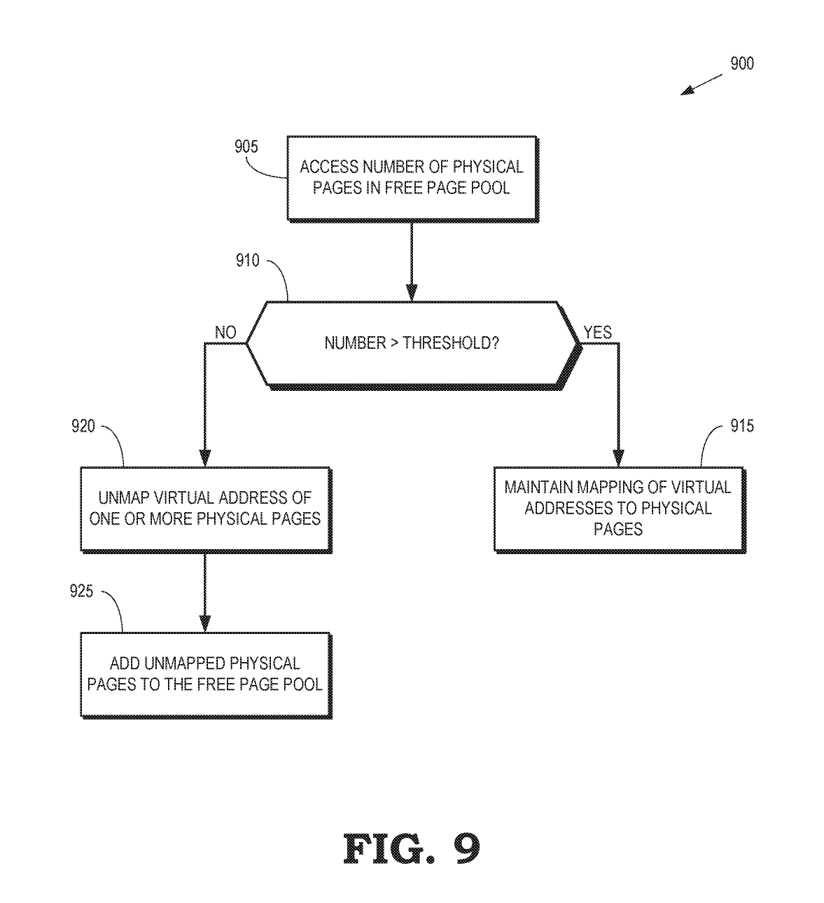

FIG. 9 is a flow diagram of a method 900 for reclaiming physical pages from a local store and adding them to a free page pool according to some embodiments. The method 900 is implemented in some embodiments of the application 135 shown in FIG. 1, the kernel mode driver 140 shown in FIG. 1, the application 215 shown in FIG. 2, or the kernel mode driver 220 shown in FIG. 2. In some embodiments, the application and the kernel mode driver may coordinate operation to implement the method 900.

At block 905, the application (or kernel mode driver) accesses information indicating a number of physical pages that are in the free page pool. For example, the processing system can maintain one or more registers that are incremented in response to adding physical pages to the free page pool, allocating physical pages to the free page pool, or reclaiming physical pages for the free page pool. The registers are decremented in response to pulling physical pages from the free page pool, mapping them to virtual addresses, and adding the mapped physical pages to a local store.

At decision block 910, the application (or kernel mode driver) compares the number of physical pages in the free page pool to a threshold value. If the number is greater than the threshold value, indicating that a sufficient number of physical pages are available in the free page pool, the application (or kernel mode driver) maintains (at block 915) the current mapping of virtual addresses to physical pages and does not reclaim any physical pages for the free page pool. If the number is less than the threshold value, the method flows to block 920.

At block 920, the application (or kernel mode driver) unmaps virtual addresses of one or more physical pages that are included in the local store in the local memory. Some embodiments of the application (or kernel mode driver) select physical pages in the local store for unmapping based on access bits or dirty bits included in the physical pages, as discussed herein. At block 930, the application (or kernel mode driver) as the unmapped physical pages to the free page pool so that the unmapped physical pages are available for on-demand allocation.

Physical pages can be reclaimed and added to the free page pool at any time. Pulling physical pages from the free page pool or adding them to the free page pool does not change the allocated memory or virtual addresses, it just changes the physical pages that are in the free page list. In some variations, only virtual addresses that are currently unmapped and flagged as wanting dynamic allocation are mapped by the hardware to pages in the free page pool. The application should not access pages in the free page pool using virtual address synonyms such as the original direct virtual address otherwise incoherent results may occur. Also, the kernel mode driver should wait until all potential dynamic allocations have been suspended before changing or removing pages from its free page list.

In some embodiments, certain aspects of the techniques described above are implemented by one or more processors of a processing system executing software. The software includes one or more sets of executable instructions stored or otherwise tangibly embodied on a non-transitory computer readable storage medium. The software includes the instructions and certain data that, when executed by the one or more processors, manipulate the one or more processors to perform one or more aspects of the techniques described above. The non-transitory computer readable storage medium includes, for example, a magnetic or optical disk storage device, solid state storage devices such as Flash memory, a cache, random access memory (RAM) or other non-volatile memory device or devices, and the like. The executable instructions stored on the non-transitory computer readable storage medium are implemented in source code, assembly language code, object code, or other instruction format that is interpreted or otherwise executable by one or more processors.

A computer readable storage medium includes any storage medium, or combination of storage media, accessible by a computer system during use to provide instructions and/or data to the computer system. Such storage media include, but are not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method for reduction of a virtual memory page fault rate in a system that includes a first memory to store a dataset and a second memory to store a subset of the dataset, the method comprising:
receiving a memory access request including a virtual address;
map a first physical page in a free page pool of the second memory to the virtual address in response to the virtual address not being mapped to a second physical page in the second memory; and
granting the memory access request to the first physical page.

2. The method of claim 1, wherein the memory access request is a request to write to the virtual address, and wherein mapping the first physical page to the virtual address comprises initializing the first physical page to a known state.

3. The method of claim 2, further comprising:
writing information to the first physical page on the basis of the virtual address.

4. The method of claim 1, wherein the memory access request is a request to read information stored at the virtual address, and the method further comprises:
spawning a process to generate the information that is to be read in response to the memory access request;
writing the generated information to the first physical page on the basis of the virtual address; and
reading the generated information from the first physical page.

5. The method of claim 1, further comprising:
allocating a plurality of physical pages including the first physical page to the free page pool.

6. The method of claim 5, wherein mapping the first physical page to the virtual address comprises removing the first physical page from the free page pool.

7. The method of claim 6, further comprising:
determining a number of physical pages in the free page pool;
unmapping at least one physical page from at least one corresponding virtual address in response to the number being less than a threshold; and
adding the at least one unmapped physical page to the free page pool.

8. The method of claim 1, wherein receiving the memory access request comprises receiving the memory access request in response to the virtual address missing entries in at least one address translation buffer associated with at least one cache that is configured to cache information stored in the second memory.

9. The method of claim 1, further comprising:
updating a page table to indicate the mapping of the virtual address to the third physical page.

10. An apparatus comprising:
a first memory to store a dataset;
a second memory to store a subset of the dataset; and
a processing unit configured to:
receive a memory access request including a virtual address;
map a first physical page in a free page pool of the second memory to the virtual address in response to the virtual address not being mapped to a second physical page in the second memory; and
grant the memory access request to the first physical page.

11. The apparatus of claim 10, wherein the memory access request is a request to write to the virtual address, and wherein the processing unit is configured to initialize the first physical page to a known state.

12. The apparatus of claim 11, wherein the processing unit is configured to write information to the first physical page on the basis of the virtual address.

13. The apparatus of claim 10, wherein the memory access request is a request to read information stored at the virtual address, and wherein the processing unit is further configured to:
spawn a process to generate the information that is to be read in response to the memory access request;
write the generated information to the first physical page on the basis of the virtual address; and
read the generated information from the first physical page.

14. The apparatus of claim 10, wherein the processing unit is further configured to allocate a plurality of physical pages including the first physical page to the free page pool.

15. The apparatus of claim 14, wherein the processing unit is further configured to:
remove the first physical page from the free page pool in response to mapping the first physical page to the virtual address.

16. The apparatus of claim 15, wherein the processing unit is further configured to:
determine a number of physical pages in the free page pool;
unmap at least one physical page from at least one corresponding virtual address in response to the number being less than a threshold; and
add the at least one unmapped physical page to the free page pool.

17. The apparatus of claim 10, further comprising:
at least one cache that is configured to cache information stored in the second memory; and
at least one address translation buffer associated with the at least one cache, wherein receiving the memory access request comprises receiving the memory access request in response to the virtual address missing entries in the at least one address translation buffer.

18. The apparatus of claim 10, further comprising:
a page table configured to store mappings of virtual addresses to physical addresses in the first memory and the second memory, wherein the processing unit is configured to modify the page table to indicate the mapping of the virtual address to the first physical page.

19. An apparatus comprising:
a processing unit;
a first memory to store a dataset, wherein the first memory has a first latency to memory access requests from the processing unit; and
a second memory to store a sparse subset of the dataset, wherein the second memory has a second latency to memory access requests from the processing unit, and wherein the second latency is shorter than the first latency, and
wherein the processing unit is configured to:
receive a memory access request including a virtual address;
map a first physical page in a free page pool of the second memory to the virtual address in response to the virtual address not being mapped to a second physical page in the second memory; and
grant the memory access request to the second physical page that is mapped to the virtual address.

20. The apparatus of claim 19, wherein the memory access request is a request to write to the virtual address, and wherein the processing unit is configured to initialize the first physical page to a known state.

21. The apparatus of claim 20, wherein the processing unit is configured to write information to the first physical page on the basis of the virtual address.

22. The apparatus of claim 19, wherein the memory access request is a request to read information stored at the virtual address, and wherein the processing unit is further configured to:
spawn a process to generate the information that is to be read in response to the memory access request;
write the generated information to the first physical page on the basis of the virtual address; and
read the generated information from the first physical page.
